(19) United States
(12) Patent Application Publication
(10) Pub. No.: US 2019/0382006 A1
(43) Pub. Date: Dec. 19, 2019

(54) SITUATION-DEPENDENT DECISION-MAKING FOR VEHICLES

(71) Applicant: ZF Friedrichshafen AG, Friedrichshafen (DE)

(72) Inventors: Stefan ELSER, Tettnang (DE); Michael WALTER, Heerbrugg (CH)

(73) Assignee: ZF Friedrichshafen AG, Friedrichshafen (DE)

(21) Appl. No.: 16/489,650

(22) PCT Filed: Aug. 14, 2018
(86) PCT No.: PCT/EP2018/072055

§ 371 Date: Aug. 28, 2019

(30) Foreign Application Priority Data
Sep. 12, 2017 (DE) 10 2017 216 061.6

(51) Int. Cl. B60W 30/09; B60W 30/095; B60R 21/0134; G08G 1/16

(52) U.S. Cl. CPC B60W 30/09; B60W 30/0956; B60W 2550/10; G08G 1/166; B60R 21/0134

(57) ABSTRACT

Disclosed is an evaluation device for determining a vehicle action, wherein the evaluation device is configured to supply an artificial neural network, which outputs the vehicle action, with data regarding a vehicle environment. The artificial neural network predicts an accident situation on the basis of these data, to evaluate a damage function for personal injury and/or material damages, calculated on the basis of simulated vehicle actions, and to determine the vehicle action for which the damage function delivers the lowest results in this accident situation. Also disclosed is a computer program product for obtaining a damage function based on personal injury and/or material damages, a method for training an artificial neural network that minimizes a damage function through reinforcement learning, a system for controlling a vehicle for making situation-dependent decisions, and a driver assistance system that has a system according to the disclosure, or an artificial neural network.

### RELATED APPLICATIONS

This application is a filing under 35 U.S.C. § 371 of International Patent Application PCT/EP2018/072055, filed Aug. 14, 2018, claiming priority to German Patent Application 10 2017 216 061.6, filed Sep. 12, 2017. All applications listed in this paragraph are hereby incorporated by reference in their entireties.

### TECHNICAL FIELD

The present disclosure relates to an evaluation device for determining a vehicle action, a computer program product, a method for training an artificial neural network, a system for controlling a vehicle for making situation-dependent decisions in an accident situation, and a driver assistance system.

### BACKGROUND

Vehicles known from the prior art are equipped with numerous sensors, which allow for a large area of the vehicle's environment to be monitored. Known collision reaction systems, e.g., emergency brake assistance and/or airbag deployment systems attempt to determine a point in time in which action is to be taken to obtain a predefined reaction, e.g., emergency braking, airbag deployment, or an avoidance maneuver, using data from these sensors. The reactions are based on manually predefined scenarios. In complex real situations, a number of reactions are possible at various points in time, which are difficult to define manually.

### SUMMARY

This is the basis for the present disclosure. One object of the present disclosure is to create a system that makes situation-dependent decisions for a vehicle in an accident situation. In particular, the system should not only carry out a predefined reaction, it should also be capable of considering another solution, e.g., making an avoidance maneuver at an earlier point in time, thus entirely avoiding a collision.

This object is achieved with an evaluation device for determining a vehicle action that has features as disclosed herein, a computer program product that has features as disclosed herein, a method for training an artificial neural network that has features as disclosed herein, a system for controlling a vehicle for making situation-dependent decisions in an accident situation that has features as disclosed herein, and a driver assistance system that has features as disclosed herein.

Advantageous embodiments and further developments of the present disclosure are also described herein.

The evaluation device according to the present disclosure for determining the action of a vehicle is carried out in order to provide an artificial neural network, which outputs the vehicle action, with data relating to a vehicle environment. The artificial neural network is configured to predict an accident situation based on this data, evaluate a damage function for personal injury and/or material damages calculated on the basis of simulated vehicle actions for this accident situation, and to determine the action of the vehicle resulting in the least damage in this accident situation.

An evaluation device is a device that processes input information and outputs a result. In particular, an evaluation device is an electronic circuitry, e.g., a central processing unit, or a graphics processing unit.

A vehicle action is a vehicle action, by means of which an accident is avoided, as well as a vehicle action that can reduce the consequences of an accident. Vehicle actions, by means of which an accident can be avoided, are interventions in the longitudinal and/or transverse control, e.g., braking, steering, and/or accelerating. A vehicle action for reducing the consequences of an accident comprises, e.g., locking a safety belt with a belt tensioner, or deploying an airbag.

An artificial neural network is an algorithm that is executed on an electronic circuitry, and is programmed on the basis of the neural network of the human brain. Functional units of an artificial neural network are artificial neurons, the output of which generally results in a value for an activation function, evaluated over a weighted sum of the input plus a systematic error, the so-called bias. Artificial neural networks are trained, in a manner similar to that of the human brain, by testing numerous inputs with various weighting factors and/or activation functions. The training of an artificial neural network using predetermined inputs is referred to as machine learning. Forward propagation comprises addition and outputting by the activation function. A subgroup of machine learning is deep learning, in which a series of hierarchical layers of neurons, so-called hidden layers, are used for carrying out the process of machine learning. An artificial neural network with numerous hidden layers is a deep neural network. Artificial intelligence refers to the appropriate reactions to unfamiliar information.

Deep neural networks enable an efficient encoding of a complex state space through the arrangement of hidden layers in which complex reaction models can be encoded.

In particular, the artificial neural network is executed on the evaluation device.

Data are logical values and/or physical values, e.g., electrical signals.

A damage function, also referred to as a cost or utility function, is a function that describes the value assigned to a specific state or a specific action.

The advantage of the evaluation device according to the present disclosure is that, among other things, the artificial neural network is capable of reacting to unfamiliar situations in an optimal manner, due to the generic properties and the efficient encoding of a complex state space in the artificial neural network. The vehicle action that is to be determined for which the results of the damage function are minimal in this accident situation, can mean in particular that, e.g., another automobile in a parallel lane may be rammed, in order to avoid a frontal collision. The decisive value in this case is always that of the damage function. If the value of the damage function for the vehicle action of ramming a parallel automobile is lower than the value for the vehicle action of a frontal collision, the artificial neural network would select the vehicle action of ramming the automobile parallel to it. In contrast, a known collision reaction system would only be capable of reacting to the frontal collision with a predefined reaction, e.g., emergency braking or deploying an airbag.

Advantageously, the artificial neural network is designed to determine the vehicle action that allows the accident situation to be avoided. The artificial neural network would therefore not necessarily execute a predefined reaction, e.g., deploying an airbag at the last possible moment, but would also consider the possibility of making an avoidance maneuver at an earlier point in time, for example, and thus entirely avoiding an accident, in particular a collision.

In an embodiment, the artificial neural network is configured to determine the vehicle action through reinforcement learning.

Reinforcement learning refers to a series of methods in machine learning in which an agent, the artificial neural network in this case, learns a strategy autonomously for maximizing results. The agent is not shown in advance which action is the best in a specific situation, and instead is rewarded at specific points in time, wherein this can also comprise negative reinforcement. Based on these rewards, the agent approximates a utility function, the damage function in this case, which describes the value of a specific state or action. Complex physical models and the multifaceted situations are learned implicitly through reinforcement learning, and need not be defined for each special case.

Advantageously, the vehicle actions comprise steering, braking, and/or accelerating the vehicle, and/or deploying a collision device, preferably an airbag, or a sequence of the above vehicle actions, wherein the parameters for the vehicle action comprise the points in time when a respective vehicle action is taken, and preferably values for the steering angle, braking force, and/or braking period, and/or the acceleration, and/or period of acceleration. The artificial neural network is therefore not only configured to determine an appropriate driving action for a specific accident situation, but instead is also configured to determine how long and which action is optimal for the respective vehicle action.

The evaluation device is preferably configured to vary the vehicle action parameters, wherein the evaluation device is preferably configured to vary the vehicle action parameters with a random number generator.

A random number generator is a method that generates a series of random numbers.

The artificial neural network has the possibility of considering various vehicle actions for a specific accident situation through a random sequence of vehicle actions, or through a random variation of a learned sequence of vehicle situations.

Personal injury is preferably given a greater priority than material damage in the damage function.

An object is not a person. In particular, an animal is regarded as an object.

As a result, the artificial neural network can determine the vehicle action resulting in the least personal injury.

In an embodiment, the damage function does not take personal features, preferably age, sex, physical and/or mental constitution, into account. As a result, any qualification based on personal features is suppressed in evaluating an unavoidable accident situation.

Among other things that enter into the sense of decency for any reasonable person is an ethical perspective. By suppressing qualification based on personal features, ethical codes of behavior for equal treatment of all humans are not infringed on by the present disclosure.

Advantageously, personal injury and/or material damage are weighted in the damage function depending on the severity of the damage. As a result, the artificial neural network can determine the vehicle action resulting on the whole in minimal severity in an unavoidable accident situation.

Particularly preferably, personal injury is weighted in the damage function according to death, injury with consequences, injuries that can be remedied, and minor injuries. This series descends in value, wherein a lower value relates to less damage.

Material damages are preferably weighted in the damage function according to the value of the losses regarding the respective object.

Based on the weighting of personal injury and material damages, it is possible to evaluate the severity of the damages in a simple manner.

In a further development, the damage function is a function of all material damages in the vehicle environment, or a function of the material damages to the vehicle. Consequently, two different types of material damage are defined.

The evaluation device is preferably configured to determine the vehicle action resulting in the least possible personal injury. A reduction in the number of personal injuries is ethically justifiable. This does not include compensation for victims.

In another embodiment, the evaluation device is configured to determine the vehicle action with the lowest material damages with the lowest number of people involved for the case where two specific vehicle actions are determined that result in the same personal injuries based on the results of the damage function. As a result, it is possible to keep the resulting overall damages to a minimum.

The computer program product is configured to be uploaded into the memory of a computer, and comprises software code segments with which an accident situation of a vehicle is simulated, wherein personal injury and/or material damages are calculated for this accident situation based on vehicle actions, vehicle action parameters, and a damage model, in order to obtain a damage function on the basis of these personal injuries and/or material damages, when the computer program product is run on a computer, wherein the vehicle action comprises steering, braking and/or acceleration of the vehicle, and/or deployment of a collision device, preferably an airbag, or a sequence of the above vehicle actions, the parameters for the vehicle action for the point in time when a respective vehicle action is to be taken, and preferably the value for the steering angle, braking force and/or braking period, and/or the acceleration and/or period of acceleration, and personal injury are given priority over material damages in the damage model, wherein personal injury and/or material damages are weighted on the basis of the severity of damage, wherein personal injuries are weighted according to death, injuries with consequences, injuries that can be remedied, and minor injuries, and material damages are weighted according to losses regarding the value of the material, wherein the damage function does not take personal features, preferably age, sex, physical and/or mental constitution, into account, and the damage function is a function of all material damages in the vehicle environment, or a function of the material damages to the vehicle.

Computer program products normally comprise a series of commands, through which the hardware is caused to execute a specific procedure when the program is installed, such that a specific result is obtained. When the program in question is used on a computer, the computer program product causes an effect, specifically obtaining a damage function as a function of personal injury and/or material damage.

A computer is a device for processing data that functions by means of programmable calculation specifications.

A memory is a medium for storing data.

Software is a collective term for programs and the associated data. The complement to software is hardware. Hardware refers to the mechanical and electronic elements in a data processing system.

It is advantageously possible with the computer program product according to the present disclosure to simulate vehicle behavior as well as damage models for participants, e.g., the extent of injury to a person, and the losses in value to a vehicle and/or an infrastructure. A damage function can be made available to an artificial neural network through these simulations. Complex physical models and the multifaceted situations can be learned implicitly by the artificial neural network through the simulations.

In an embodiment, the artificial neural network is configured to evaluate a damage function obtained with the computer program product according to the present disclosure. The artificial neural network can then be trained through reinforcement learning in a comprehensive simulation to select the best outcome for all participants in an impending accident, or to avoid the accident entirely.

The evaluation device preferably has an input interface for obtaining data from vehicle environment sensors, preferably camera, radar, lidar, infrared, and/or ultrasonic sensors.

An interface is a device between at least two functional units in which an exchange of logical values, e.g., data, or physical values, e.g., electronic signals, takes place, either unidirectionally or bidirectionally. The exchange can be analog or digital. The exchange can also be hard-wired or wireless.

Current vehicles already have vehicle environment sensors. As a result, it is particularly easy to obtain data regarding the vehicle environment.

The artificial neural network is executed on an evaluation device in the method according to the present disclosure for training an artificial neural network. According to the present disclosure, the method comprises the following steps:
providing data regarding a vehicle environment,
predicting an accident situation on the basis of these data,
learning a damage function through reinforcement learning, calculated on the basis of simulated vehicle actions, to evaluate personal injury and/or material damages, and to determine the vehicle action in which the damage function delivers the lowest results in this accident situation.

The artificial neural network is preferably executed on an evaluation device for determining a vehicle action.

An artificial neural network can be trained with the method according to the present disclosure to react in an optimal manner to previously undefined situations, in order to avoid an accident situation.

An evaluation device according to the present disclosure is preferably used for executing the method.

The system according to the present disclosure, for a vehicle control system for making situation-dependent decisions in an accident situation has an input interface for obtaining data regarding a vehicle environment. The system also has an evaluation device that is configured to forward propagate an artificial neural network that has been trained with reinforcement learning with these data, in order to determine the vehicle action for an accident situation for which a damage function delivers the lowest results in this accident situation, based on personal injury and/or material damage, and to obtain a signal for a vehicle control system on the basis of this vehicle action. The system also has an output interface configured to output this signal to a vehicle control device.

A vehicle control device is a device that executes or assumes the longitudinal and/or transverse control of a vehicle.

Because the artificial neural network is already trained with reinforcement learning, an end-to-end solution for avoiding or reducing the consequences of an accident is provided through the forward propagation of this artificial neural network with data regarding the vehicle environment. In particular, the system can react in an optimal manner to unfamiliar situations, on the basis of the generic properties of the artificial neural network.

The evaluation device is preferably configured to determine the vehicle action for an impending accident situation by means of which the accident situation can be avoided. As a result, the overall damage can be minimized with the system. The evaluation device can also determine the vehicle action that ensures an outcome with minimal overall damages when an accident is unavoidable.

The artificial neural network of the system is preferably trained according to the method of the present disclosure.

A driver assistance system according to the present disclosure has a system according to the present disclosure, or an artificial neural network that has been trained according to the method of the present disclosure.

### BRIEF DESCRIPTION OF THE DRAWINGS

The present disclosure shall be described comprehensively in reference to the following figures.

FIG. 1 shows an exemplary embodiment of an evaluation device according to present disclosure;

FIG. 2 shows an exemplary embodiment of a computer program product according to present disclosure;

FIG. 3 shows an exemplary embodiment of a method according to present disclosure; and

FIG. 4 shows an exemplary embodiment of a system according to present disclosure.

### DETAILED DESCRIPTION

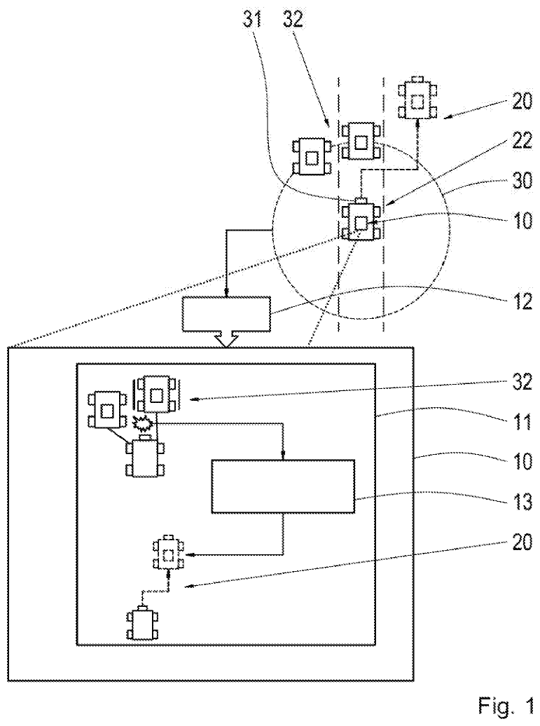

FIG. 1 shows an impending accident situation 32 for a vehicle 22 approaching two other vehicles on a roadway. If the vehicle 22 continues to travel in the same direction in its lane, it will collide with the vehicle in front. This accident situation 32 is a frontal collision.

The vehicle 22 has a camera serving as the vehicle environment sensor 31. The camera 31 records data 30 regarding the environment of the vehicle 22. The camera 31 records the two vehicles in front as data in the environment. The vehicle 22 can also be equipped with a set of sensors, e.g., in the form of camera, radar, and lidar sensors, serving as the vehicle environment sensor 31. Such a sensor set exploits the combined respective advantages of the individual sensors through sensor fusion.

The data from the vehicle environment sensors 31 are conveyed to an evaluation device 10 via an input interface 12. The evaluation device 10 can be a computer processor, in particular a multi-core processor. The evaluation device 10 is located on the vehicle 22. The evaluation device 10 can also be located at a central location, outside the vehicle 22, within the scope of the present disclosure, wherein the vehicle 22 sends the data 30 regarding the vehicle environment to the evaluation device 10 for evaluation, and the evaluation device 10 returns the results of the evaluation to the vehicle 22.

The evaluation device 10 contains an artificial neural network 11. The artificial neural network 11 is a deep neural network with numerous hidden layers in which the driving of the vehicle 22 in a vehicle environment is encoded on the basis of a number and arrangement of hidden layers in the form of a complex state space. The artificial neural network 11 can also be a convolutional neural network. Convolutional neural networks are multi-layer artificial neural networks in which each layer contains independent neurons. Convolutional neural networks with repeated layers are called deep convolutional neural networks.

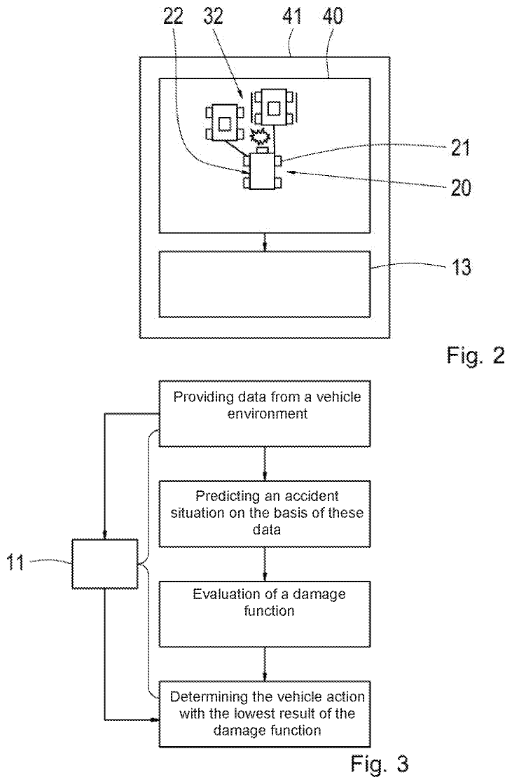

The artificial neural network 11 evaluates the accident situation 32 for a given damage function 13. The damage function 13 is provided by the computer program product 40 shown in FIG. 2. Based on the state of the accident situation 32, the damage function 13 outputs the vehicle action 20 for which the damage function has the lowest results, i.e., resulting in minimal overall damage in the accident situation 32. The vehicle action 20 is an avoidance maneuver, such that a frontal collision with the vehicles in front never occurs.

The computer program product 40 in FIG. 2 is uploaded to a memory in a computer 41, and executed in this computer 41. Software code segments of the computer program product 40 simulate accident situations 32 for a vehicle 22. The computer program product 40 calculates vehicle action parameters 21, e.g., the period of a braking or acceleration procedure, and a damage model for personal injury and/or material damages for this accident situation 32 based on vehicle actions 20, e.g., driving straight on, braking, swerving to the right or left. Based on these personal injuries and/or material damages, the computer program product obtains a damage function 13. Personal injuries are weighted more heavily than material damages in the damage model, wherein personal injuries and/or material damages are based on the severity of the damage, wherein personal injuries are weighted according to death, injuries with consequences, injuries that can be remedied, and minor injuries, and material damages are weighted according to losses in value for the respective object. The damage function does not take personal features, preferably age, sex, physical and/or mental constitution, into account, and the damage function is a function of all material damages in the vehicle environment, or a function of material damages to the vehicle. The value of the severity of the damage in material damages corresponds to a loss of value for the vehicle, other vehicles, or an object in the infrastructure, e.g., a building.

In the method shown in FIG. 3, data regarding a vehicle environment are provided to an artificial neural network in an evaluation device. An accident situation is predicted on the basis of these data. The artificial neural network 11 learns to evaluate a damage function 30 for this accident situation 32 by means of reinforcement learning for personal injuries and/or material damages calculated on the basis of simulated vehicle actions 20, and to determine the vehicle action 20 for which the damage function delivers the lowest value in this accident situation 32.

By providing data 30 regarding a vehicle environment, the artificial neural network 11 can observe the vehicle 22 environment, and be rewarded for appropriate actions that are carried out. After the artificial neural network 11 has determined the vehicle action 22 with the lowest damage function 13, the vehicle 22 continues to observe the environment through the provision of data regarding the vehicle environment.

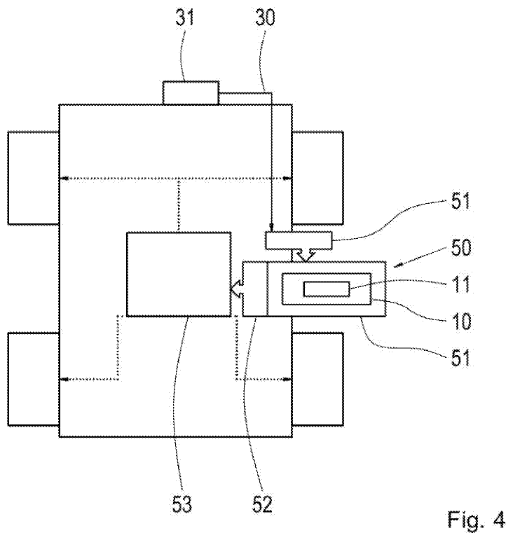

FIG. 4 shows a vehicle control system 50. The system 50 has an input interface 51, via which data from a vehicle environment sensor 31 is sent to the system 50. The system 50 has an evaluation device 10, which forward propagates an artificial neural network that has been trained by reinforcement learning with these data, in order to determine the vehicle action 20 for an accident situation 32, for which a damage function 13 delivers the lowest results in this accident situation, based on personal injury and/or material damages. A signal is obtained for controlling a vehicle on the basis of this vehicle action 20. This signal is output to a vehicle control device 53 via an output interface 52.

As a result, a driver assistance system can be advantageously provided, which automatically reacts in the optimal manner to an impending accident situation by means of an end-to-end solution, independently of predefined scenarios.

### REFERENCE SYMBOLS

10 evaluation device

11 artificial neural network

12 input interface

13 damage function

20 vehicle action

21 vehicle action parameter

22 vehicle

30 data

31 vehicle environment sensor

32 accident situation

40 computer program product

41 computer

50 system

51 input interface

52 output interface

53 vehicle control device

1. An evaluation device for determining a vehicle action, wherein the evaluation device is configured to:
supply an artificial neural network, which outputs the vehicle action, with data regarding a vehicle environment, wherein the artificial neural network is configured to:
predict an accident situation based on these data;
evaluate a damage function for the accident situation, calculated on a basis of simulated vehicle actions, for at least one of personal injury or material damages; and
determine the vehicle action for which the damage function delivers the lowest results in this accident situation.

2. The evaluation device according to claim 1, wherein the artificial neural network is configured to determine the vehicle action with which the accident situation can be avoided.

3. The evaluation device according to claim 1, wherein the artificial neural network is configured to determine the vehicle action through reinforcement learning.

4. The evaluation device according to claim 1, wherein the vehicle action comprises at least two of steering the vehicle, braking the vehicle, accelerating the vehicle, or deploying an airbag,
wherein the vehicle action further comprises a sequence of the above vehicle actions, and
wherein vehicle action parameters comprise:
points in time when a respective vehicle action is to be initiated, and
values for at least one of a steering angle, a braking force a braking period, an acceleration, or a period of acceleration.

5. The evaluation device according to claim 4, wherein the evaluation device is configured to vary the vehicle action parameters with a random number generator.

6. The evaluation device according to claim 1, wherein the artificial neural network is configured to weight personal injuries more than material damages in the damage function.

7. The evaluation device according to claim 1, wherein the artificial neural network is configured such that the damage function does not take into account personal features comprising age, sex, physical or mental constitution.

8. The evaluation device according to claim 1, wherein the artificial neural network is configured to weight at least one of personal injuries or material damages on a basis of the severity of the damage in the damage function.

9. The evaluation device according claim 1, wherein the artificial neural network is configured to personal injuries in the damage function according to death, injury with consequential damages, remediable injury, and light injury.

10. The evaluation device according to claim 1, wherein the artificial neural network is configured to weight material damages in the damage function according to loss in value for the respective object.

11. The evaluation device according to claim 1, wherein the damage function is at least one of a function of all material damages in the vehicle environment or a function of the material damages to the vehicle.

12. The evaluation device according to claim 1, wherein the evaluation device is configured to determine the vehicle action with the lowest number of personal injuries.

13. The evaluation device according to claim 1, wherein the evaluation device is configured to determine which vehicle action results in the lowest material damages with the lowest number of participants for two specific vehicle actions for which the damage function results in the same personal injuries.

14. A non-transitory computer-readable medium comprising a computer program that, when executed by a computer, cause the computer to perform the following:
simulate an accident situation of a vehicle; and
calculate vehicle action parameters and a damage model of at least one of personal injuries or material damages for the accident situation, on a basis of vehicle actions to obtain a damage function based on the at least one of the personal injuries or the material damages,
wherein the vehicle actions comprise at least two of steering the vehicle, braking the vehicle, accelerating the vehicle or deploying an airbag,
wherein the vehicle action further comprises a sequence of the above vehicle actions,
wherein vehicle action parameters comprise:
points in time when a respective vehicle action is to be initiated, and
values for at least one of a steering angle, a braking force, a braking period, an acceleration, or an acceleration period,
wherein, in the damage model;
personal injuries are weighted more than material damages,
personal injuries and material damages are weighted on a basis of the severity of damage,
personal injuries are weighted according to death, injuries with consequential damages, remediable injuries, and minor injuries, and
material damages are weighted according to a loss in value to the respective object,
and wherein the damage function does not take into account personal features comprising age, sex, physical or mental constitution, and the damage function is at least one of a function of all material damages in an environment of the vehicle or a function of the material damages to the vehicle.

15. (canceled)

16. The evaluation device according to claim 1, further comprising an input interface configured to obtain data from at least one environment sensor of the vehicle, wherein the at least one environmental sensor comprise at least one of a camera, radar, lidar, infrared, or ultrasonic sensor.

17. The evaluation device according to claim 1, wherein the artificial neural network is trained by:
learning, through reinforcement learning, to evaluate the damage function for the at least one of the personal injuries or the material damages.

18. (canceled)

19. A vehicle control system for making situation-dependent decisions in an accident situation, comprising:
an input interface for obtaining data regarding a vehicle environment;
an evaluation device configured to:
forward propagate an artificial neural network that has been trained through reinforcement training with the data regarding the vehicle environment, in order to determine a vehicle action for an accident situation for which a damage function delivers the lowest results based on at least one of personal injury or material damages in the accident situation; and
obtain a signal for controlling a vehicle based on this vehicle situation; and
an output interface configured to output the signal to a vehicle control device.

20. The system according to claim 19, wherein the evaluation device is configured to determine the vehicle action for the accident situation with which an accident can be avoided.

21. (canceled)

22. (canceled)
